(19) United States
(12) Patent Application Publication
(10) Pub. No.: US 2003/0097664 A1
(43) Pub. Date: May 22, 2003

(54) Method and system for interactive movie scene television

(76) Inventors: James Meyers, (US); Sunder Aaron, (US); Scott Anderson, (US)

Correspondence Address: James Meyers, 3765 Wasatch Avenue, Los Angeles, CA, 90066, US

(21) Appl. No.: 10/001,118

(22) Filed: Nov. 21, 2001

(51) Int. Cl. H04N 7/20; H04N 7/173; H04N 7/16

(52) U.S. Cl. 725/138; 725/135; 725/90; 725/115; 725/116; 725/73

(57) ABSTRACT

The invention presents for its viewers a distinctive and unduplicated combination of unique television programming joined directly with related interactive services and features. An improved method and apparatus for programming a television network are disclosed. The method and apparatus enables viewers to watch television programming comprised almost wholly of entertainment scenes, view and navigate information, product, merchandise and premium television services lists, directly purchase these products, merchandise and services which are directly related to the comprised programming. Also detailed is the process of attaching and managing the data which attends the broadcast and interactive services, and any sales to the viewer. It is especially useful audiovisual programming that provides unique and unduplicated interactive content for viewers, Pay TV operators, while supplying unique and unduplicated promotional services for motion picture studios, entertainment programming producers, and premium television networks.

### COPYRIGHT NOTICE

This patent document contains material subject to copyright protection. The copyright owner, Cinema Entertainment Group, LLC, has no objection to the reproduction of this patent document or any related materials, as they appear in the files of the Patent and Trademark Office of the United States or any other country, but otherwise reserves all rights whatsoever.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAMMING LISTING COMPACT DISCK APPENDIX

Not Applicable

### BACKGROUND OF THE INVENTION

1. Field of the Invention

The present invention relates to interactive television, and more particularly to a method and system for providing interactive television consisting of scenes excerpted from motion pictures, thus allowing networks to generate revenue from multiple sources.

2. Description of Related Art

Television networks can be categorized based upon the types of programming they offer and the way they generate revenue. The types of programming offered by television networks can be divided into two categories: general programming and specialized programming. Networks that have general programming (e.g., ABC, NBC, FOX) air programs specific to a target audience presumed to be watching at a particular time on a particular day. Alternatively, networks that have specialized programming (e.g., MTV, The Weather Channel, HBO) continually air programs specific to a core theme. MTV, for example, provides music video programming.

Television networks are also defined by their method of generating revenue. The two methods most television networks use for generating revenue are subscription fees and advertising/sponsorship. Although most networks charge some subscription fee and show some commercials, other television networks generate revenues by either exclusively charging monthly subscription fees or showing commercials. HBO, for example, provides commercial free programs in exchange for a relatively high subscription fee. Others, like ABC, provide free programming in exchange for a high volume of commercials.

The ultimate television network would provide the consumer subscription free, limited commercial, interactive programming that allows the consumer to select the programs that would be watched. A network, such as this, would also provide the television networks with additional methods of generating revenue (e.g., merchandise sales, special movie/game viewings). A need exists in the industry, and it would be very desirable, for a method and system that provided interactive television consisting of scenes excerpted from motion pictures, thus allowing the consumers to select the programs that would be watched, while providing the networks with multiple sources for revenue generation.

### BRIEF SUMMARY OF THE INVENTION

The invention is a new digital television network which distinctively combines on-screen interactive television features (including movie information, sell through options for Video on Demand, Pay per view, subscriptions to premium networks, and sell through options for movie oriented merchandise e.g. CDs, DVDs, VHS, movie posters, books, movie tickets) with a unique new television programming format comprised of complete scenes from motion pictures edited together with similar themed scenes in themed blocks of programming.

Thus, in one aspect, the present invention provides a method of providing entertainment content on a television network. The method comprises selecting at least one scene from an entertainment production or event. The selected scene is delivered to one or more viewers. By way of example, the entertainment production can be in the form of a motion picture, such as a cinematic motion picture (e.g., that opened originally in theatres) or a made-for-television motion picture; a television program such as an episode of a television series (e.g., a drama or a situation comedy); a sports event; or the like. Scene TV can be delivered in any suitable manner, such as, for example, broadcasting, wire delivery (e.g., cable), the internet, satellite, or the like, or combinations thereof.

In another aspect, the present invention provides a television network dedicated to providing scenes of entertainment content. The network comprises scene programming. In the scene programming, least one scene from an entertainment production or event is shown. In a preferred embodiment, at least 50% of the network's programming is such scene programming. In some embodiments, at least 60%, at least 70%, at least 80% or at least 90% of the network's programming is such scene programming.

The invention may best be understood with reference to the accompanying drawings and in the following detailed description of the preferred embodiments.

### BRIEF DESCRIPTION OF THE DRAWINGS

FIG. 1 illustrates an embodiment of how products can be ordered and delivered, and monies collected through Scene TV television network. Scene TV programming, along with its Web page, are provided to subscribers through a television distribution platform and the Internet. Subscribers are provided with movie and advertisement content supplied from sponsors and movie studios.

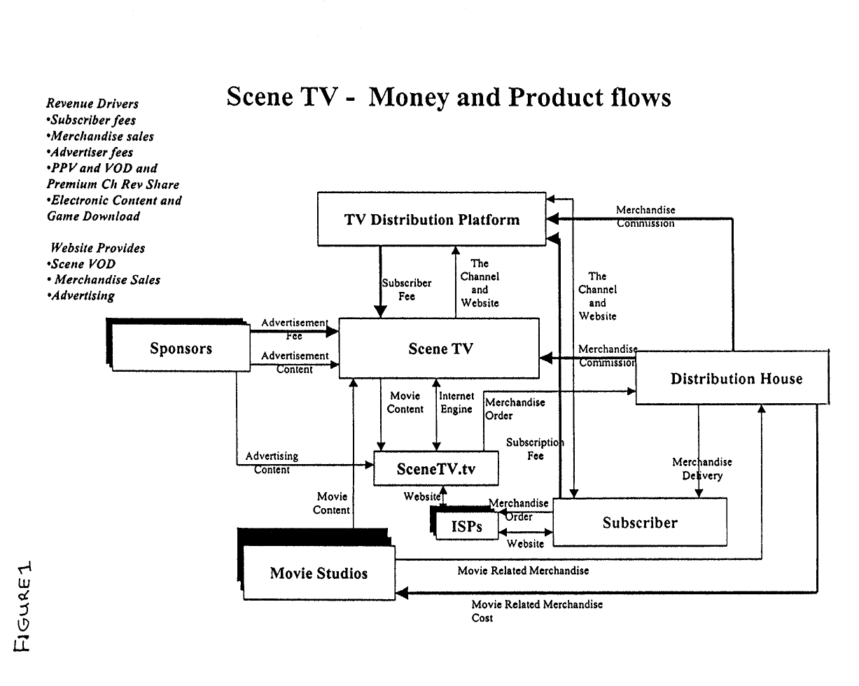

FIG. 2 is an overview diagram illustrating an embodiment of consumer interaction with Scene TV television network. The subscriber is able to use a television and set top box to interface with Scene TV's broadcast signal distributed via satellite and system operator.

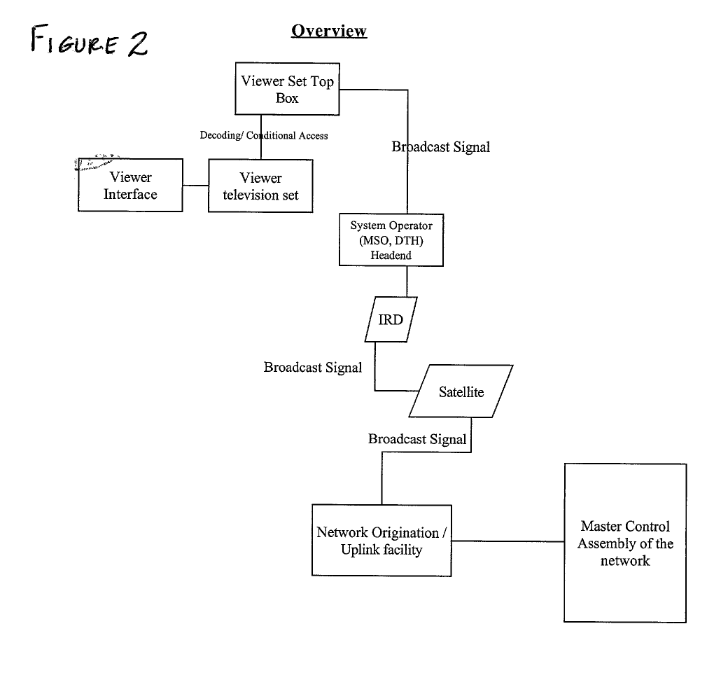

FIG. 3 is a flow chart illustrating an embodiment of merchandise orders through Scene TV television network. Merchandise ordered through Scene TV's Internet link are tagged, enabling a portion of the monies collected to be directed to Scene TV and/or the operator.

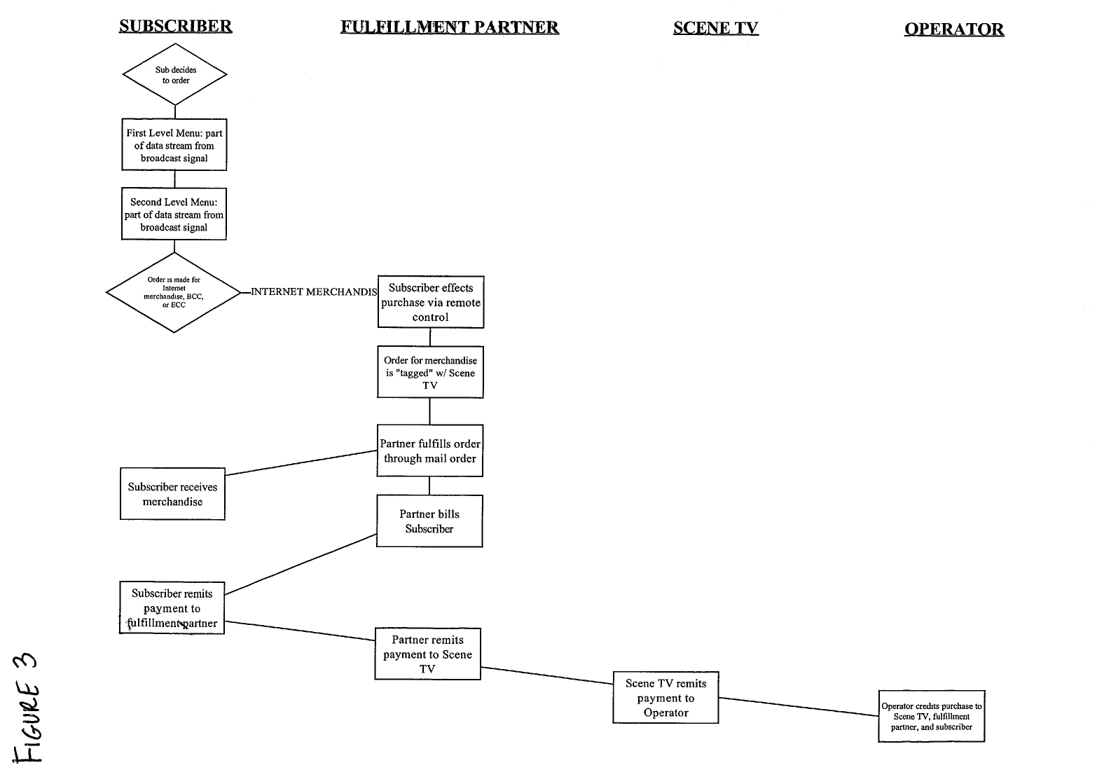

FIG. 4 is a flow chart illustrating an embodiment of broadcast, PPV, and premium orders through Scene TV television network. Scene TV provides the selected service to the subscriber. If the selected service costs money (e.g., PPV or premium), the order is tagged, enabling a portion of the collected monies to be directed to Scene TV.

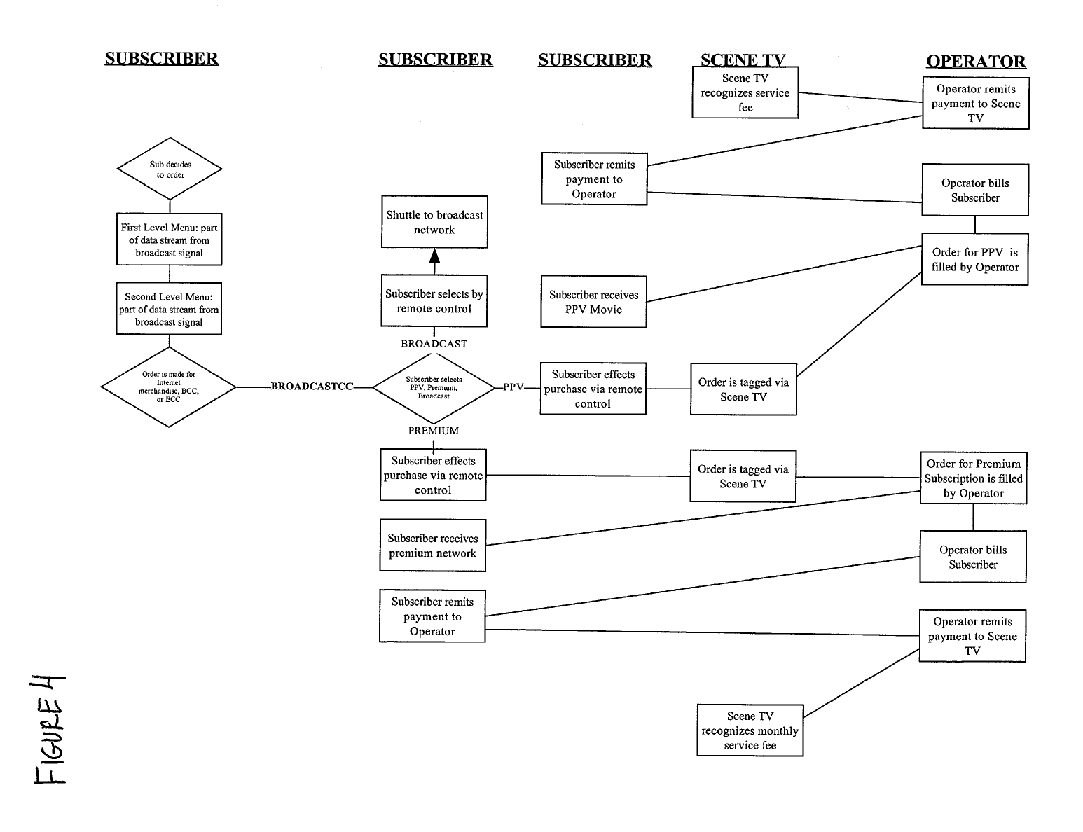

FIG. 5 is a flow chart illustrating an embodiment of ticket, VOD, and game orders through Scene TV television network. Scene TV provides the selected service (or product) to the subscriber. VODs ordered through Scene TV are tagged, enabling a portion of the collected monies to be directed to Scene TV. Tickets and games ordered through Scene TV are tagged, enabling a portion of the collected monies to be directed to Scene TV and/or the operator.

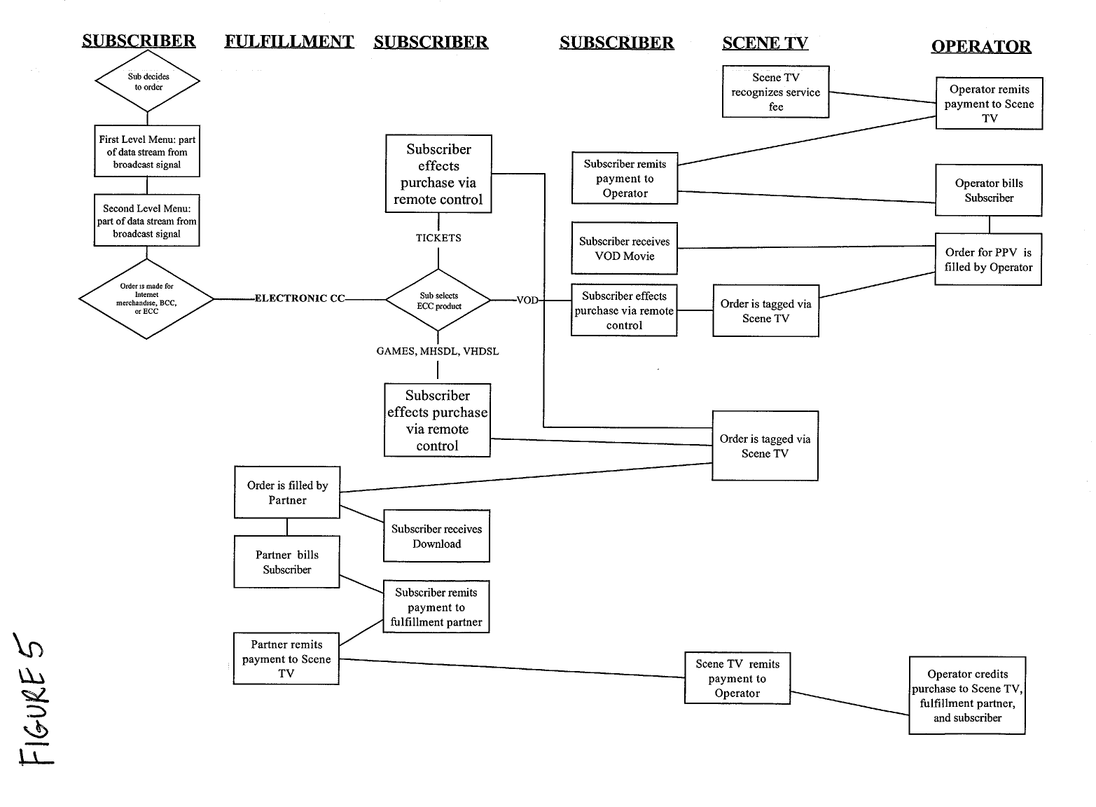

FIG. 6 illustrates an embodiment of the overall network operations associated with Scene TV television network. Data is brought into the baseband processing system. The baseband processing system outputs content that is sent to the uplink signal processing system, the SI/EPG system, and the CA system.

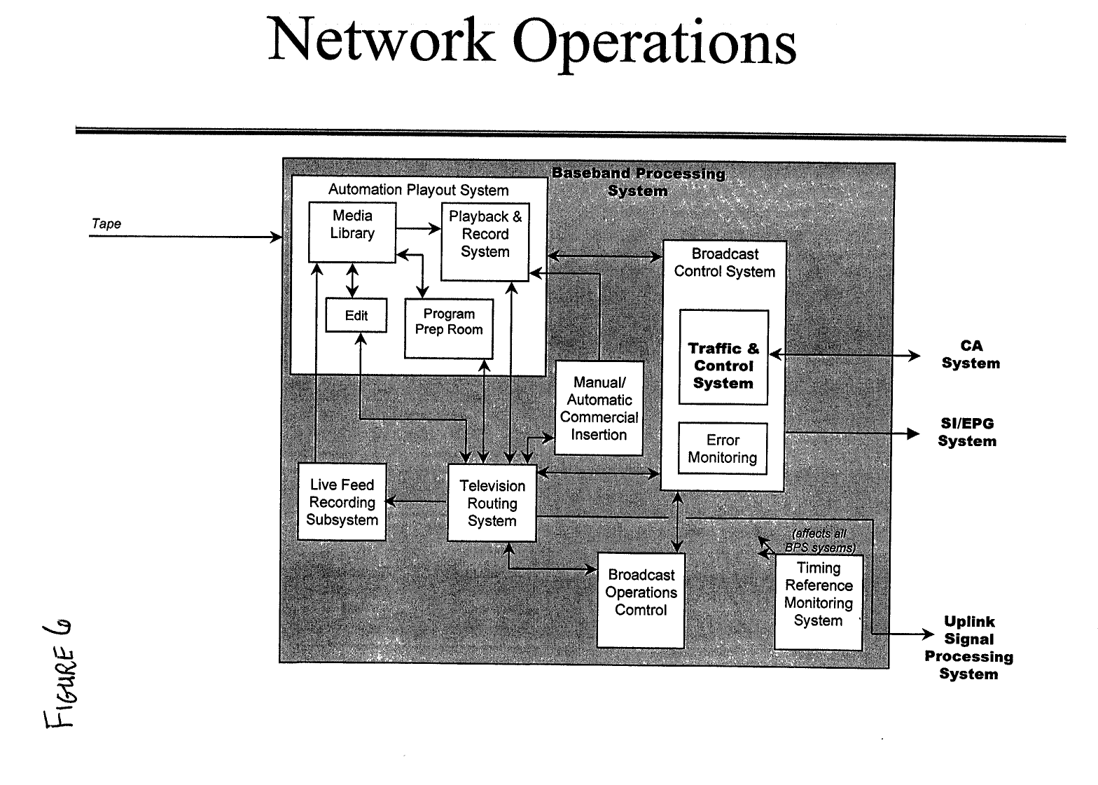

FIG. 7 illustrates an embodiment of the network operations encoding system associated with Scene TV television network. The video and audio from the baseband processing system are encoded and multiplexed with a digital data interface. Forward error correction and modulation is then performed before the data is sent to the RF system.

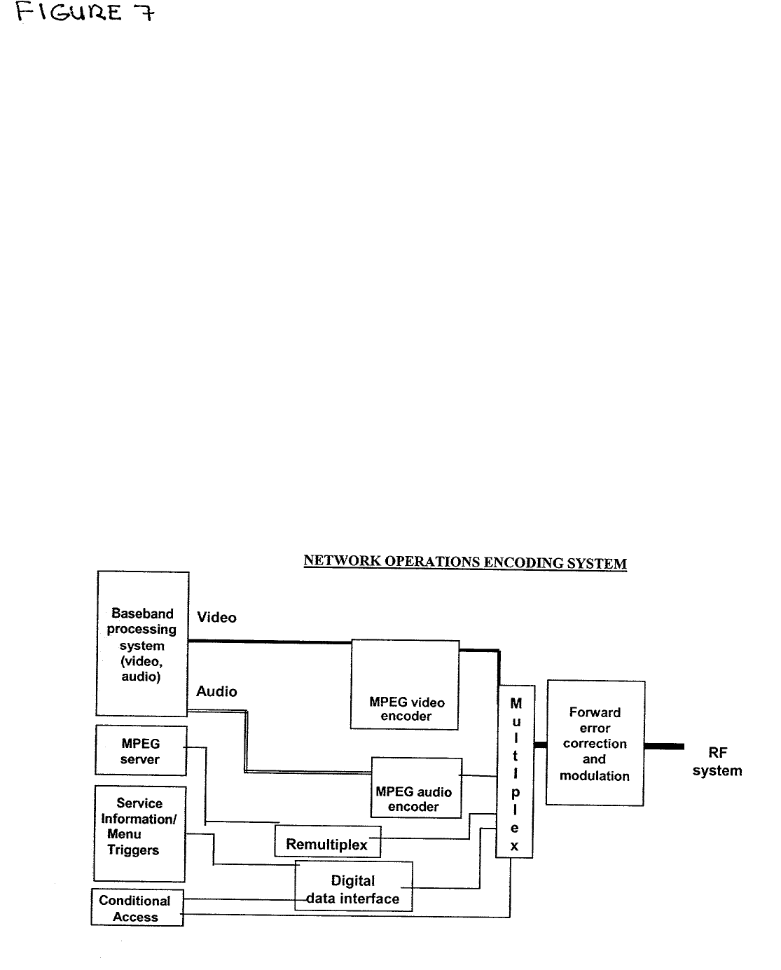

FIG. 8 illustrates an embodiment of the service information system associated with Scene TV television network. A timing reference monitoring system (also shown in FIG. 6) and a traffic control system processes data that is sent on to the digital data interface.

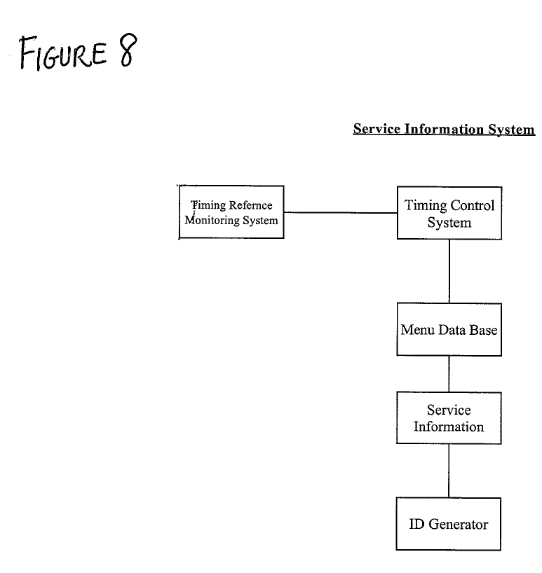

FIG. 9 illustrates an embodiment of Scene TV's television back office server. Scene TV's back office server contains sales data from fulfillment houses and sales and remittance data from MSOs. Such information may reside in the data warehouse.

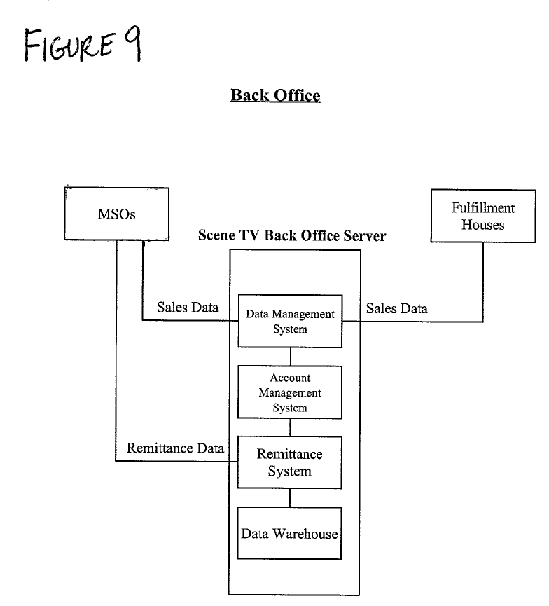

FIG. 10 illustrates the various agreements that exist in an embodiment of Scene TV television network. These agreements include carriage agreements on advanced digital pay television systems, promotional agreements with television networks, content agreements with movie studios, and fulfillment agreements with partners.

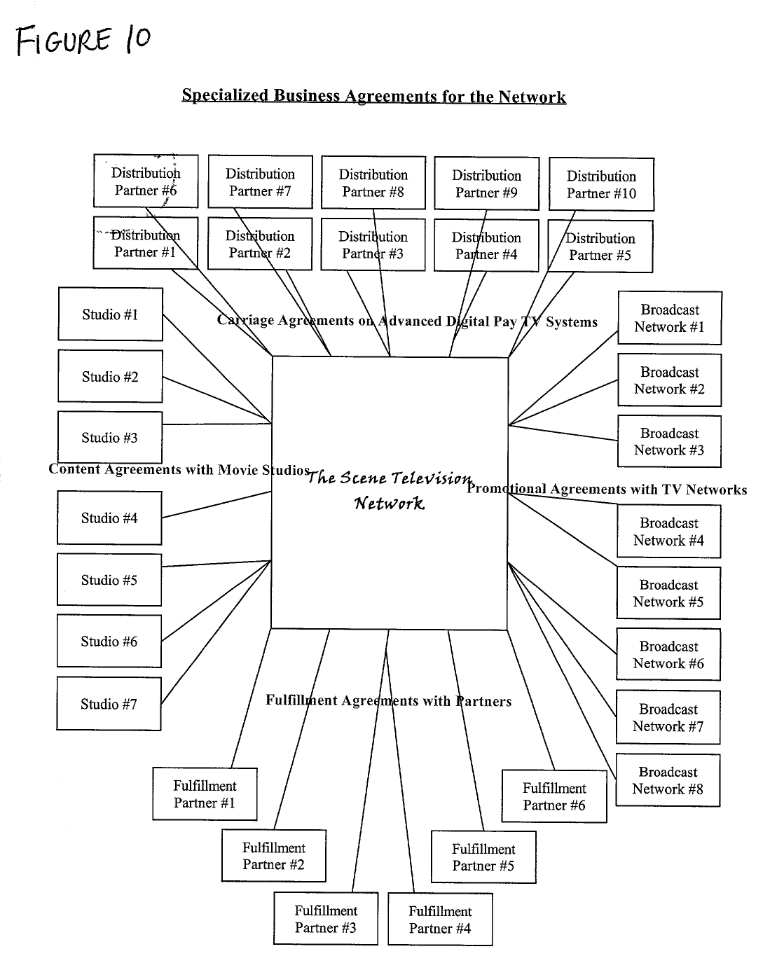

FIG. 11 illustrates an embodiment of the scene selection process associated with Scene TV television network. Scenes are extracted from selected films provided by the movie studios. These scenes are submitted to the studio for final approval and cataloged. The scenes are then digitized and stored on the servers, where they are later used to generate theme blocks of programming.

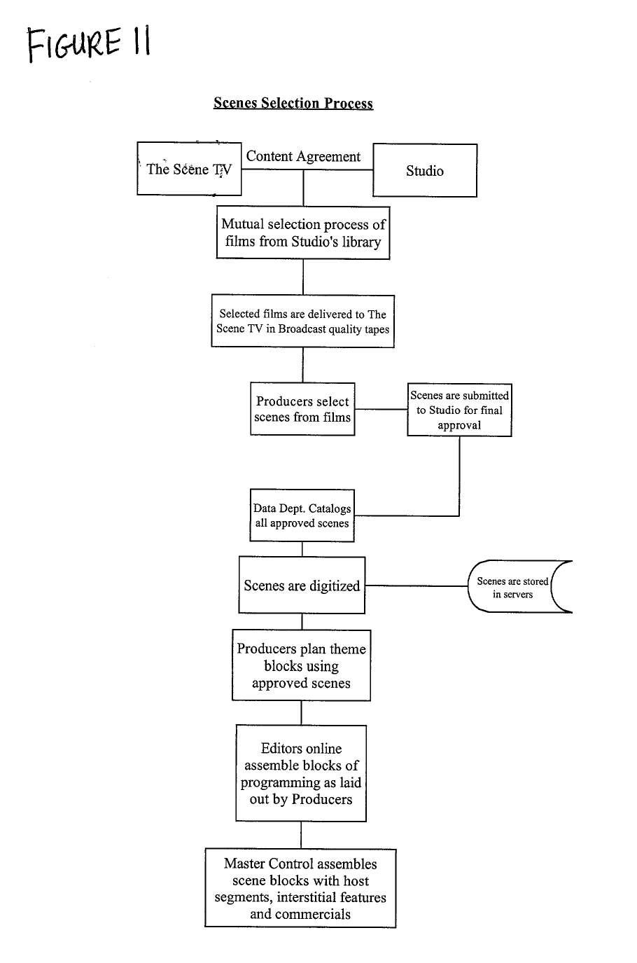

FIG. 11A illustrates in greater detail the scene selection process as it is in conjunction with the motion pictures studio. This detailed process involves the producers for Scene TV television network and approval from the studio.

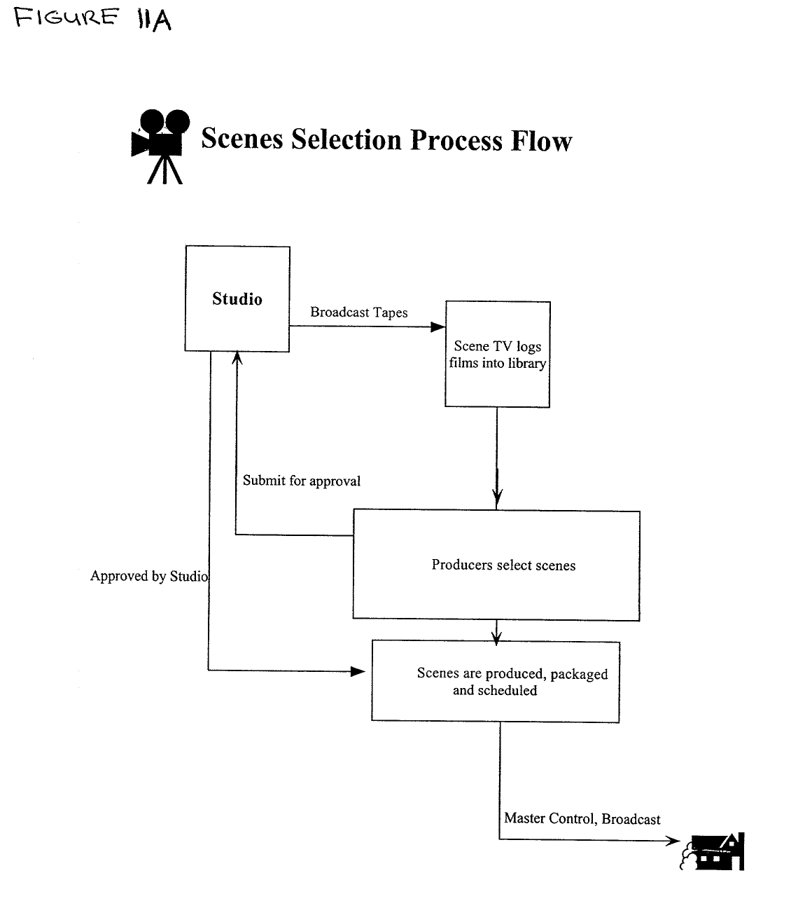

FIG. 12 illustrates an exemplary weekly schedule of the programming offered by Scene TV television network. A variety of programming is available to the subscriber. The programming consist of theme blocks, which are geared for a particular audience at a particular time on a particular day. For example, War is Hell is shown Monday night at 11:00 PM.

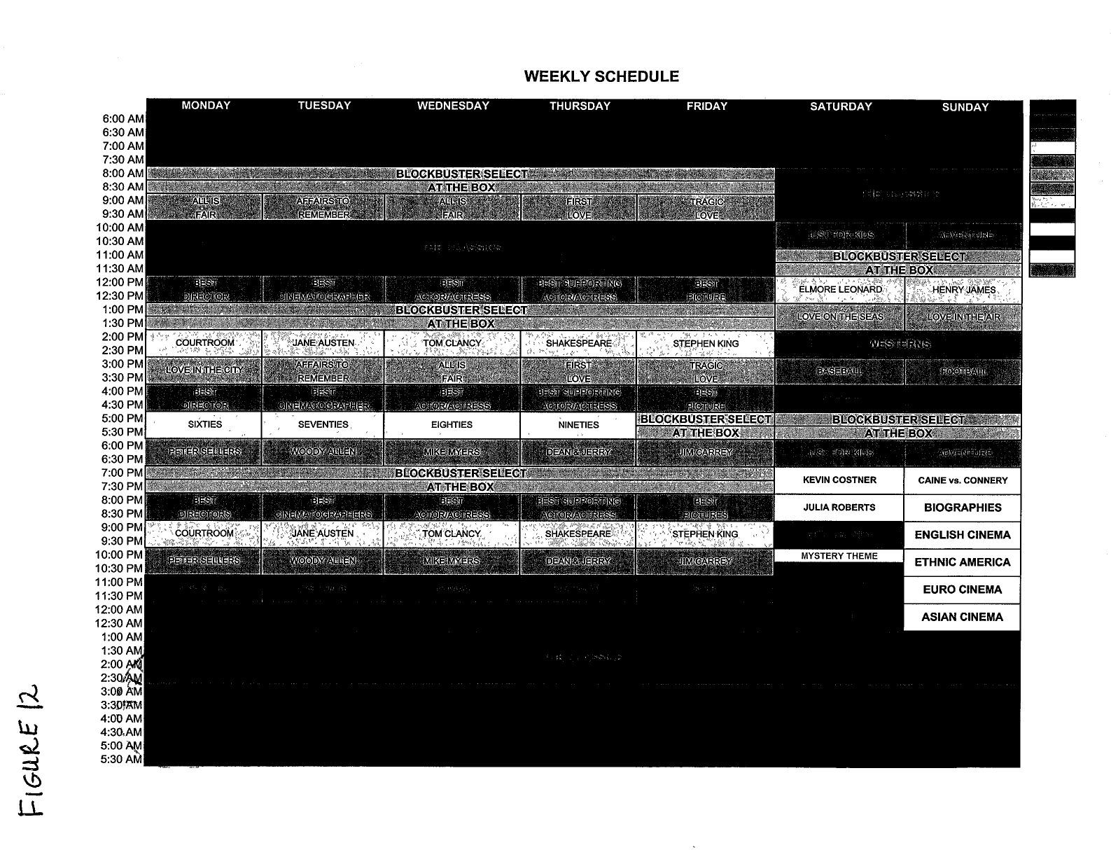

FIG. 13 illustrates an exemplary daily schedule of the programming offered by Scene TV television network. Each theme block is further divided into movie scenes. For example, War is Hell, which is shown Monday night at 11:00 PM, contains scenes from movies pertaining to war, like “A Bridge Too Far” or “Patton.”

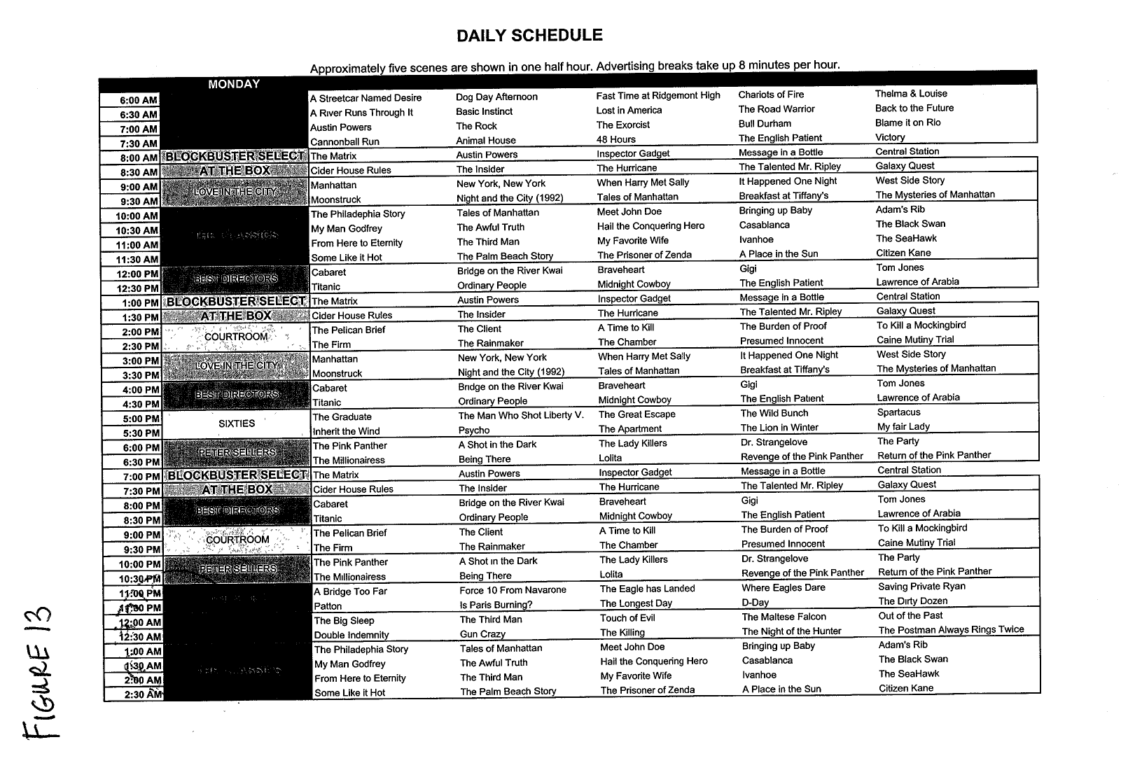

FIG. 14 contains a description of the exemplary daily programming depicted in FIG. 13. For example, War is Hell is an action theme with a sub-theme of war and battle.

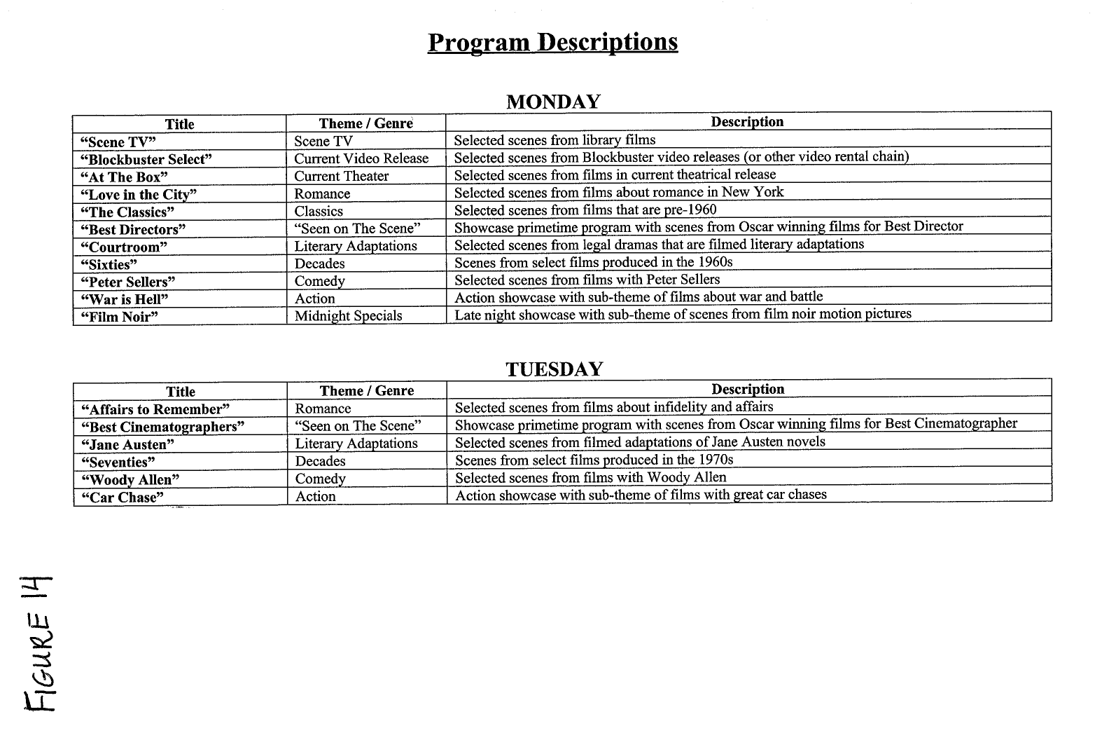

FIG. 15 illustrates the flow of data which accompanies sale of merchandise on Scene TV. The process also illustrates the tie-in with a motion pictures studio accounting department, coordination with Cable Operator and fulfillment company, and TV screen that the viewer at home proceeds from.

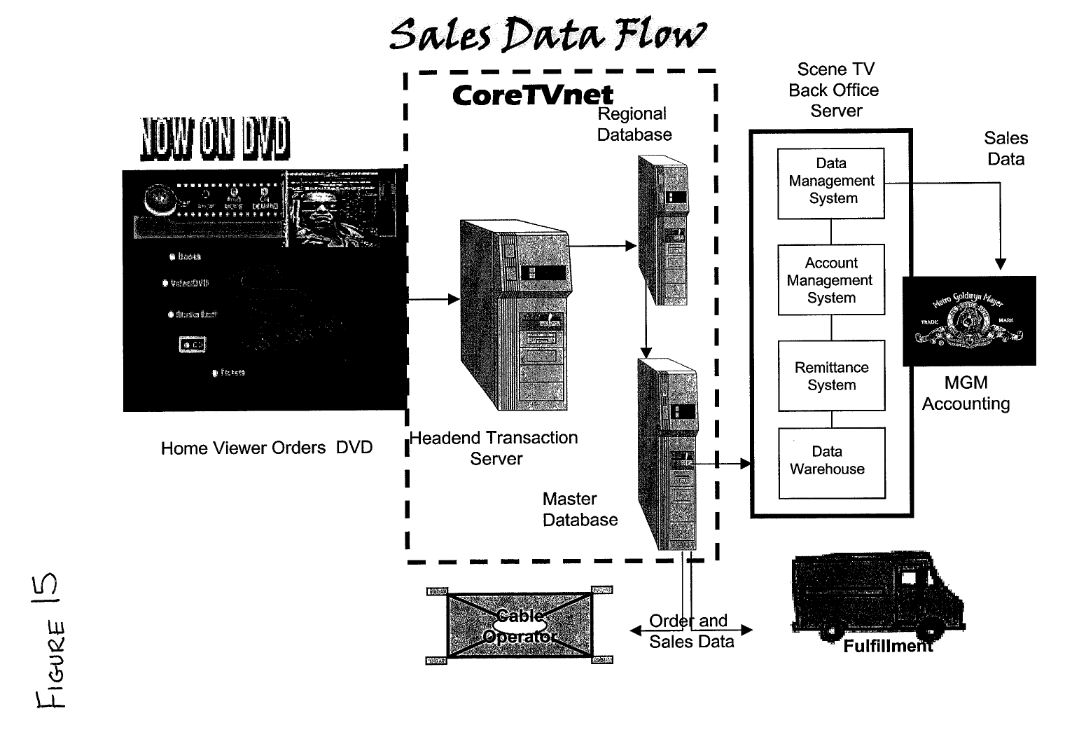

FIG. 16 illustrates the name and symbol (“Scene TV”) which has been successfully trademarked.

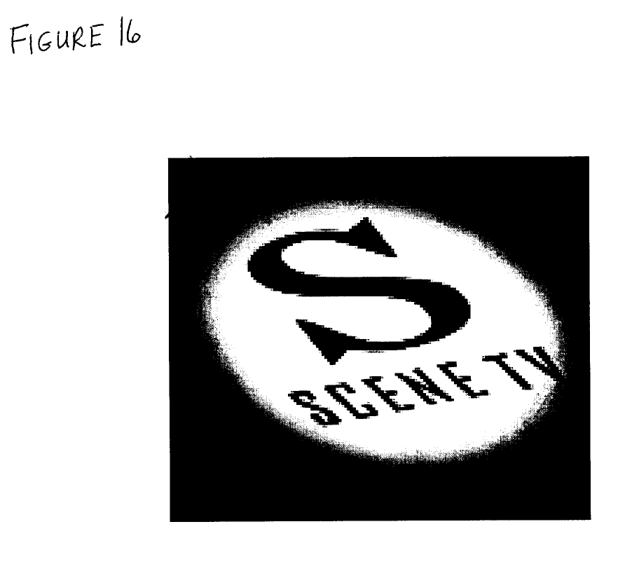

### DETAILED DESCRIPTION OF THE PREFERRED EMBODIMENTS

Description of the Television Network's Unique Aspects

One of the primary and unique aspects of the business is the invention of a singular and never-before utilized programming format for the television network. The television network is programmed using scenes excerpted from motion pictures (actual scenes are utilized, not trailers or previews). These unedited scenes are selected and excerpted in their entirety from the motion pictures. Selected scenes are then combined with similar scenes in themed blocks of programming. Blocks of scenes are introduced by Hosts (known as “Cinema Jockeys”, or Cee-Jays) in interstitial segments. Because a scene represents the simplest element of a motion picture, each scene itself tells a story (with a beginning, middle and an ending). Cee-Jays present the scenes and discuss their particular relevance. In introductions, hosts will also talk about special stories behind the making of the scenes.

Another primary and unique aspect of the business is the invention of specialized interactive television menus which relate directly to each scene that is shown on the network. A viewer who is watching a particular scene may utilize his remote control to “bring-up” on-screen menus which allow the viewer to (1) Gain more background information about the scene and motion picture; (2) Order products and merchandise that are related to the scene and motion picture; (3) Order a viewing of the entire motion picture from pay per view; (4) Order a viewing of the entire motion picture from video on demand; (5) Order a viewing of the entire motion picture from a premium television network; (5) Determine where else on the Pay TV system the motion picture can be seen; (6) Order electronic tickets related to motion pictures; (7) High speed download to advanced set top box, digital video recorder, video games console and/or some other media appliances of electronic products related to the scene and motion picture (e.g. music soundtrack, motion picture, video game etc.)

Another primary and unique aspect of the business is the invention of customized interactive television software applications which enable and manage the combination of data streams in combination with each scene which comprises the network's television programming.

Another primary and unique aspect of the business is the creation of unique business agreements with a number of motion pictures studios and other film library owners for the license to promote and program using selected scenes from their motion pictures. Typical business agreements with the motion pictures studios will allow the licensee to promote and program using the entire motion picture. Unique business agreements will also be created with several premium and broadcast television networks (such as HBO, Showtime etc.). These agreements are unique in their design to promote and drive viewers to purchase subscriptions via Scene TV. Premium networks will benefit through the increased interactive sales of their networks through Scene TV.

Another primary and unique aspect of the business is the creation of unique business agreements with a number of Pay TV system operators. These agreements will allow for distribution of the network on their systems coupled with unique arrangements for the sharing of revenues between the network and the system operators.

Another primary aspect of the business is the unique and successfully trademarked name, branding and positioning of the television network.

A More Complete Discussion of the Concept:

The company will primarily base its brand and industry position on the creation of a new television channel especially suited for delivery via digital platforms. It will then combine this traditional model of a television channel with the interactive power of broadband digital platforms and the Internet.

The new television channel, called “Scene TV”, will be distributed via digital television systems (cable, DTH) with a format modeled after music video channels. However, instead of music videos, Scene TV will be programmed using favorite scenes taken from well-known movies. Each scene will last no longer than 5 minutes and will be sourced from recognizable films. When each scene begins and ends, Scene TV will list for a few seconds in the lower left corner of the screen the names of the Director, Producer, Studio and a premium network (or video store chain) where the movie can be seen.

On advanced digital distribution systems that offer interactive services, Scene TV will have attached on-screen menus that allow direct Pay per View and Video on Demand rentals, and other enhanced TV services. Enhanced TV services shall include opportunities for purchases (via remote control and set top box) of books, DVDs, video games, electronic tickets, posters, soundtrack CDs (as well as Pay per Listen services), and other studio oriented merchandise. Viewers will also be given menu driven access to background information regarding the actors, directors, writers and producers of the movie with its scene shown. All these services will also be available through audio and video streaming options at www.SceneTV.tv.

Programming will be sourced through agreements with the studio marketing and merchandising departments. The studios will grant Scene TV its programming content In exchange for promotion and distribution of their properties and merchandise on Scene TV. The studio's marketing, merchandise, PPV and VOD groups will naturally benefit from the promotional aspect of having scenes aired on Scene TV. Although studios will be providing the scenes at little or no cost, they will reap exceedingly greater revenues from increased video/DVD rentals and sales, boosted merchandise sales, and several other revenue streams that are unique to Scene TV's business model. Movie scenes will be selected through a mutual approval process with the studios.

A More Complete Discussion of the Programming & Positioning:

Scene TV will provide a unique and exceptionally entertaining new source of entertainment. Scene TV will look and feel like a preferred channel. Because it is of paramount importance that Scene TV does not appear to be a barker or preview channel, the service will only air movie scenes, and will exclude previews and movie trailers. Similar programming is already prevalent on channels such as E! Entertainment Television, and television programs such as Entertainment Tonight.

Although Scene TV will select its scenes through a mutual approval process with the studios, Scene TV will direct editing of its scenes to best control the quality and appearance of the service.

1. Format

The programming concept for Scene TV is compelling because everyone loves movies. Programming is comprised of movie scenes each lasting an average of ten minutes or less. In a typical hour, the scenes and attendant host segments/interstitials will comprise 52 minutes worth of programming, with advertising filling the remaining eight minutes.

By limiting the advertising to eight minutes per hour (well below the average advertising per hour for cable or broadcast networks), Scene TV will be perceived as a content focused premier destination for the viewers. Advertisers will benefit from a media environment that provides greater share of voice, and little clutter. In adherence to the quality appearance of Scene TV, the channel will only air advertising messages for studio products and other entertainment oriented merchandise and services. In this way, even the advertising content of Scene TV will create a strongly positive association between Scene TV and cinema itself.

We have estimated that in the year prior to launch (Year 0), 450 new films will be acquired for use. In the first year of broadcast (Year 1), scenes will be required from approximately an additional 740 different films. This volume will allow the channel to remain fresh while broadcasting for 24 hours and retaining great variety in its programming. The number of newly accessible films required to keep the service fresh will decline each year as Scene TV's library grows. After Year 2, the channel will only need to add 520 new movies to its library every year.

Theme blocks of programming can even be created for different dayparts or special occasions. Therefore, the programming possibilities will be almost limitless. For instance, in the early afternoons on weekdays, Scene TV can feature scenes from well-known kids and family movies. On late night Friday evenings, Scene TV can feature scenes from horror movies. On Academy Awards night, Scene TV can feature scenes from Academy Award winning films, and on Steven Spielberg's birthday, Scene TV can feature scenes from all his films. Programming blocks may be created for an endless array of themes. A short list would include scenes grouped together by:

Movie theme
Lead actors/actresses
Directors
Genre
Period or location
Cinematographer

2. Internet Component

Video streaming over the Internet is a vital component of the programming plan for Scene TV. While scheduled programming will exist on the digital TV channel, all scenes from the monthly library will also be available for on-demand streaming at www.SceneTV.TV. Carriage on both Internet and television platforms will be critical to a complete positioning with the audience. Also, marketing efforts will benefit greatly from all cross-media promotional opportunities.

A More Complete Discussion of the Revenues:

Scene TV changes the business model for subscription television. Scene TV's model capitalizes on two important factors: (1) People love the movies; (2) Added functionality is resulting from technology advancements in the delivery of television products and services. Because Scene TV anticipates the future of television, it is one of the first channels to fundamentally change the traditional model for television networks. This fact will become most evident to operators and program suppliers through the number of different revenue sources that will result from their carriage and support of Scene TV. In fact, the main aspect of this business which sets it apart from other channels is the number of different ways in which it can generate revenues.

1. Traditional

Subscription fees—The channel will be distributed to cable operators and DTH platforms for a nominal fee per subscriber household. This will allow carriage in the operator's basic digital tier.

Advertising and Sponsorships—Scene TV will have national advertising while allowing for local advertising insertion. Eight minutes of advertising will be retained per hour (2 minutes of which will be awarded to operators for local insertion). Because this is well below the industry average for a television channel, advertisers will receive a greater share of voice, and the air time will ultimately be sold at a premium. In addition, a component of advertising that is projected to grow very large on digital systems will be “interactive” ads. Viewers will be able to access enhanced menus during advertisements as well as programming. By delivering on-demand additional information that the audience desires, Scene TV will turn viewers into consumers.

Aside from the “traditional” subscription television revenue streams of advertising and sub fees, Scene TV boasts of four additional categories of “enhanced TV services”, each serving as a separate economic engine for the business.

2. Broadcast Content Commerce

This category is for revenue generating services based on the delivery of viewers and subscribers to programming that is broadcast in real time by a third party (e.g. HBO). When a scene begins and also nears its conclusion on Scene TV, viewers will see an overlay in the lower left hand corner of the television screen which lists the following information:

Film Title

Director

Studio and Year

Premium Service Viewing

The last line of information (Premium Service Viewing) will list the movie's next showing on a premium service such as HBO. The viewer may then access the advanced on-screen menu and either order an HBO block for the few hours that will encompass the showing of the selected movie thus becoming a “Partial View Sub”, or otherwise order the complete HBO service thus becoming a “Joint Subscriber” (see below).

For all these services, Scene TV will not be required to invest in technology for these services, since all technological upgrades to a system will managed by the operator. The operator will essentially provide the fulfillment for the PPV product/services, and subscriber management.

Pay-per-View—On digital systems, the electronic navigator will allow viewers who are watching Scene TV to directly order a movie with a scene shown on the channel. Scene TV will share the sale with the operator, the studio and a pay per view provider.

Partial View Subs—With advanced services available on the digital platforms, viewers will be able to watch premium services in a pay per view manner. “Partial View Subs” are subscribers who are driven via Scene TV to order a premium service for several-hours blocks of time rather than for an entire month. Viewers will subscribe to partial viewing of premium services when they desire to view a particular movie or event program without having to pay for the entire premium service. For instance, a partial view sub may elect to pay $1.99 to watch Titanic when it premieres on HBO rather than paying $9.95 to get HBO service for one month.

Joint Subs—Scene TV will also drive viewers to become new subscribers of premium services offered by the cable operator. For instance, if a viewer watches Scene TV and upon seeing a scene from a movie that is currently on HBO, he uses the advanced digital services remote control to order the premium service offered by the operator, the new sub will be considered a “Joint Subscriber”, shared between HBO and Scene TV.

Scene TV will receive a share of the monthly sub fee typically paid to the programmer and operator. This will result in a recurring monthly revenues paid to Scene TV for driving the initial subscription of the “Joint Sub”. In a sense, Scene TV is being compensated with a sales commission for having covered the marketing expense required to attain the subscriber. A precedent already exists in another segment of the pay TV industry for this method of compensation: when DIRECTV sells a program package via a retail outlet, the retailer receives on a monthly basis a percentage of the subscriber's monthly subscription fee for a given period of years, or as long as the household remains a subscriber (whichever is less).

3. Electronic Content Commerce

This category is for revenue generating services based on the delivery of movie oriented electronic products that are not schedule restricted. While watching Scene TV, viewers will be able to use the remote control for their digital set top boxes to directly order electronic products via the channel itself. The breadth and variety of these services will increase as the platforms and set top boxes become more dynamic.

It should be noted that Electronic Content Commerce products will be offered via both Scene TV television channel and Scene TV's web site (www.SceneTV.tv).

VOD/SVOD—Scene TV will drive subscribers to the Video-on-Demand menus (and Subscription Video-on-Demand services) offered by the cable operator. The electronic navigator will allow viewers who are watching Scene TV to directly order (for personal viewing) a movie or title from a SVOD package which had a scene shown on the channel.

Video High Speed Download—If viewers prefer to own a movie title rather than watch it on a system's VOD or PPV menus, they can at high speed directly download a movie title for ownership into a home personal storage/viewing device. Appliances offering similar functionality are now available from TiVO and Replay. More robust devices will become available to consumers within the next two years.

Music High Speed Download—Viewers will be able to order music soundtracks from their favorite films via Scene TV. Advanced television platforms will allow for high speed downloads of music to each viewer's storage/viewing device.

Video Games—Viewers of Scene TV will also be able to download a variety of video games with themes that are based on movies. Games will be downloaded directly into the viewer's player console. Already, Sony has added the functionality to its next generation of Playstation (Playstation 2) that will allow for games (and other electronic media) to be downloaded into the console's memory via a fire wire. Playstation 2 is planned for North American release in Fall 2000.

Electronic Tickets—Viewers will be able to purchase a variety of movie oriented tickets electronically via Scene TV. For instance, while viewing Scene TV, a subscriber may purchase tickets for a local movie theater or musical via the system's platform. Of course, Scene TV will receive a share of the revenues as per agreements with providers of the ancillary products and services.

4. Merchandise Sales

This category is for revenue generating services based on the sales of Studio oriented merchandise via Scene TV and its web site. TV based shopping opportunities for film oriented merchandise such as videos, books, posters, clothing and CDs will be offered via the advanced commerce capabilities of digital TV platforms as well as via Scene TV's Internet web site.

In our model, the studio is providing the merchandise, the operator is providing the bandwidth, and Scene TV is providing the portal and links that lead to the merchandise. Enhanced menus will also be available for further product information.

5. Web Sales

There are three methods through which www.SceneTV.tv (Scene TV's web site) will generate sales:

Advertising and Sponsorships

Electronic Content Commerce—video games, streaming, e-tickets (see above)

Merchandise Sales—Books, videos, DVDs, CDs, apparel, posters etc. (see above)

Products and services The-Scene.tv will primarily offer are:

1) Video streaming of movie scenes, previews and trailers

2) Video games

3) Advertising/Sponsorships

4) Studio oriented merchandise sales

5) Chat rooms

6) International access

www.SceneTV.tv will offer an expanse of Scene TV's entertainment and related services. During the launch phase of Scene TV, the web site for the service will likely accept a large portion of the venture's merchandise sales. This share of merchandise sales will decrease as interactive television becomes more accessible and consumers become more comfortable with commerce transactions via the television (“T-commerce”). At some point, programming services will be available on-demand at www.SceneTV.tv.

A More Complete Discussion of the Primary Business Considerations

Scene TV satisfies operators, studios, and viewers. Scene TV is positioned for media convergence. Management has fashioned Scene TV so that the service anticipates the future of television viewing, Internet usage, and utilization of all other media applications.

The service and its offerings are equipped for delivery via advanced digital platforms, the Internet, wireless applications, and other broadband media platforms that will be available. In this sense, Scene TV will be a service that is “platform agnostic”. In any medium, commerce opportunities will always naturally flow from Scene TV's entertainment and programming offerings.

Across media, there are six primary considerations for the business: 1) Channel Distribution, 2) Studio Cooperation for Programming Licenses, 3) Artist Relations, 4) Viewership & Audience, 5) Internet Component, 6) Technology and Operations.

1. Channel Distribution

Operators (even of digital platforms) are perpetually seeking new ways to increase current revenues while creating additional revenue sources. Scene TV will be a “preferred” channel that operators of digital systems will carry in their basic tiers because the channel will provide a gateway to new services and sources of revenue. Scene TV will lay the foundations with the operator for the revenue streams that advanced systems will be capable of generating. At the same time, Scene TV will help prepare the operator's audience for future.

Scene TV is most appropriate for distribution via digital systems. This allows for the high level of interactivity that will generate additional revenues (primarily Broadcast Content, Electronic Content and Merchandise Sales). Multiple revenue streams will compel operators to add Scene TV to their channel line-ups. Doing so will be the equivalent of strapping on a new economic engine to their system businesses.

In some situations, operators will also offer Scene TV to their non-digital subscribers. Operators become more profitable as they convince existing subscribers to migrate to digital offerings. In this regard, Scene TV will be a service that can effectively drive subscriber households to order PPV and premium services, as well as driving them to upgrade to digital subscription.

Since Scene TV was designed particularly for digital platforms, Direct to Home will play a major role in the channel's distribution. DTH systems also allow for the high level of interactivity which will generate secondary revenue streams. In fact, the two major DTH providers, DirecTV and Echostar, are making great strides in interactive and E-commerce services.

2. Studio Cooperation for Programming Licenses

Scene TV will acquire its programming (movie scenes) from major studios and film library owners. Through their involvement with Scene TV and in exchange for the programming that they provide, studios will receive promotion of their properties, distribution of their program products and services, and a share in PPV, electronic content commerce, and merchandise sales. For this reason, Scene TV's program acquisitions will be tied closely to the studio merchandising and marketing divisions.

A scene's showing on Scene TV will lead to revenues for the studios in the following categories:

Pay per View sales
Electronic content
commerce sales
Video/DVD rentals
Video/DVD sales
Merchandise sales
Theatrical ticket sales

The increased turnover that results from greater utilization of their library titles will incentivize the studios and library owners to allow Scene TV to use their movies as promotion for ancillary revenue streams at either little or no license fees.

3. Artist Relations

Scene TV may require the consent of certain artists' guilds to attain rights to some film scenes. If necessary, this consent may take the form of tacit approval, or of a formal agreement.

Scene TV promotes the sales and rentals of artists' works. As such, the service will increase the market value and recognition for both artists and their works. Scene TV will also seek to create a strong cooperative relationship with the artist guilds.

Although an important consideration, it is believed guilds will not pose an obstacle for the following additional reasons:

Studio leverage—Studios which will benefit from involvement with Scene TV will have considerable influence (and experience) with artists and unions.

Partners—It is likely that Scene TV will eventually include the equity involvement of parties which are closely aligned with artists, such as studios, talent agencies, counsel with strong ties to artists, and/or a Guild itself.

Libraries—Significant volume of quality films are no longer subject to artists' rights.

Mission—Above all, Scene TV is a service that will honor the artists' works. This mission will predominate the service.

4. Viewership & Audience

In a 500 channel platform, only services which offer an unique entertainment proposition, superior value for the time viewed, and compelling products and services for its viewers will become primary entertainment destinations with large audiences.

Industry wide market research has proven over many years that movies are by far the strongest programming driver for entertainment based channels. Scene TV will quickly become a primary entertainment destination because it is a film based service that meets the insatiable appetite that viewers have for movies. It will also attract viewership quickly with its unique program format and theme-based offerings.

An essential element to creating a large and loyal audience will be the ability of Scene TV to successfully build its brand recognition. Management will commit itself to building strong marketing efforts for Scene TV. Scene TV will become a service that is exceptionally well-marketed to consumers. Marketing for Scene TV will be distinctive, compelling, and memorable.

Of course, Hollywood is one of the best industries for involvement in the creation of promotional events, contest tie-ins, and other marketing campaigns that are highly attractive to viewers. Scene TV will design and implement efforts such as contests for viewers to attend film premieres, visits to Universal Studios, appearances in films, or for winning studio oriented merchandise.

5. Internet Component

Video streaming, soundtrack streaming and merchandise sales over the Internet is a vital component of the business model for Scene TV. The eventual convergence of the TV and PC will determine whether the technology exists sooner or later for web casting and video streaming that has high enough quality to attract consumers en masse. These anticipated capabilities support the Internet generated component of Scene TV's business model.

6. Technology and Operations

As a programmer, Scene TV will not have to manage the technology aspects that are required for the channel to be a successful service. However, Scene TV will enable full use of the service operators technology. Most technology upgrades that result in the system capabilities necessary for Scene TV to generate the various streams of revenue will be the domain of the operator. As the service matures Scene TV will develop highly unique custom applications for the interactive television aspects of the service. This will include applications that allow for efficient management of data associated with interactive programming, and the creation and employment of a proprietary user interface. These proprietary applications will allow natural commerce activities to flow from viewers' interests

Expansion of the channel beyond its first stage of growth will require that significant progress be made in deploying advanced technologies as anticipated by the industry. Scene TV will then provide the content destination, interface and methods by which consumers will purchase products and services, while the actual sales transaction and “fulfillment” of Broadcast Content Commerce and Electronic Content Commerce products and services will be managed by the operator, and fulfillment of merchandise will be managed by the studios, their agents and expert fulfillment providers (such as Amazon.com and CDnow).

In fact, as Morgan Stanley Dean Witter stated in a recent industry report, the development of new technologies are no longer business risks. In their report, they further stated that all the equipment necessary for new video and data services is now available. This is largely due to the near-conclusion of development for second generation advanced digital television set top boxes. Scientific Atlanta, General Instrument and Sony all have highly advanced STBs available in the market today.

Discussion of Scene TV's Programming Strategy

Program Format

Scene TV will program its schedule using the best scenes from memorable movies. The format is similar to the initial concept of music video channels in that the service will be comprised primarily of scenes shorter than 5 minutes each and sourced from various films. The variety and volume of the selected scenes will allow the service to create themed blocks which will compel viewership.

Basic Digital Tier

The service will be positioned in basic digital cable tiers to gain access to the largest possible enabled audience. Also, Scene TV will serve to drive viewers into premium services, tiers and purchases of PPV and VOD.

A Premier Entertainment Destination

Although Scene TV (advertising supported without premium subscription fees) will not be a premium service, it will be a premier entertainment destination. Scene TV will only program using complete scenes from memorable movies, and will not be a channel that shows trailers, previews, or acts as a barker channel. Therefore, Scene TV will become a great channel to watch, with engaging programming, and a high quality appearance.

First and foremost, Scene TV is a channel that will honor film. In doing so, the quality of the scenes that are selected and the manner in which they are presented is critical. Using various scenes from films will allow the service to be programmed with themed blocks. These themes will be created with primary consideration given to the entertainment value of the block, and secondary (however substantial) consideration given to the promotional value of each program block.

Dayparts

Scene TV will have three Dayparts: Primetime, Overnight, and Daytime. Primetime (considered to be 6 PM until 12 Midnight) will feature Scene TV's best programming. On some occasions, program blocks will be stripped during the weekdays in primetime to build viewership and develop a loyal audience. The following day, Daytime (considered to be 8 AM until 6 PM) will be programmed using shows from the six hours primetime block on the previous night. Overnight (running from 12 Midnight until 8 AM) will consist primarily of programming that appeals to a late night audience. The theme blocks that will be scheduled for Overnight will include genres such as Film Noir, Action, Asian Cinema and Horror. The latter part of Overnight will also consist of “Scene TV”, an extended program block which runs random scenes without a theme block format.

Familiar Destinations

Throughout the schedule, Scene TV will use various program genres and theme blocks to create “familiar destinations” for its viewers. This will allow Scene TV to build its audience. For instance, the sample schedule allows for blocks of scenes from films with romantic and literary themes to be shown during the weekday afternoons. At this time, the television viewing audience skews towards women. With this programming strategy employed in the afternoon, Scene TV intends to establish a popular program block with the primary daytime audience.

Similar “familiar destinations” will be established in every portion of the schedule. Action and Film Noir programs are scheduled later in the evening and are fashioned to attract a viewing audience that expects to catch such programs at night. Sunday afternoons and early evenings feature scene blocks taken from film biographies and foreign films. Primetime programming will feature our best theme blocks and will often coincide with major promotional efforts at Scene TV. For example, one primetime show that is planned will be known as “Seen on Scene TV”, and will focus on the special subjects established for the week. For instance, during the week leading up to the Academy Awards, Scene TV will present several theme blocks that feature Oscar winning pictures, directors, writers and actors. The width and breadth of themes on Scene TV will only be limited by the imagination of Scene TV's editors and programming staff.

Repeats

Although the Primetime block will not be re-run as a “wheel”, it will be “sampled”. This is typical for cable channels which utilize their best programs many times throughout the week in which they are originally aired. Although some services have been known to launch with an eight or twelve hour programming wheel that is rerun intact during the day, this strategy can easily cheapen the appearance and perception of the channel. Scene TV will efficiently repeat its programs while minimizing the “rerun” channel perception that can often plague cable networks.

The scenes themselves will be utilized for many different theme blocks and also during “Scene TV” in Overnight. Therefore, the repeat factor of scenes both in repeated theme shows and new “cross-referenced” theme shows will allow Scene TV to get the greatest possible use from its library.

Programming

Scene TV will deliver the cinema experience to pay television subscribers by using short form programming to comprise its schedule. As the success of the channel grows, Scene TV will create original programming that remains consistent with the mission and appearance of the channel. For instance, future shows may include a series of retrospectives for famous directors. Of course, these shows will feature scenes from the respective director's best movies. Other original shows may include movie trivia game shows.

Special shows will also be produced such as “At the Box”, which is comprised of scenes from movies that are currently in theatrical release. “Blockbuster Select” is a program sponsored by a major national video chain that uses scenes from several of the recent top video releases.

Scene TV will also make use of host segments to introduce many of the theme blocks and special shows. Hosts, known as “Cinema Jockeys” or Cee-Jays” will also be utilized for a special “Mystery Theme” show in which viewers must determine the common theme in scenes selected for a particular block, and then use interactive methods to tell Scene TV their guesses. Viewers that are correct will win prizes such as DVDs and movie tickets.

Volume

In the year prior to launch (Year 0), 450 new films will be acquired for use. In the first year of broadcast (Year 1), scenes will be required from an additional 740 different films. This volume will allow the channel to remain fresh while broadcasting for 24 hours and retaining great variety in its programming. The number of newly accessible films required to keep the service fresh will decline each year as Scene TV's library grows. Beginning in Year 2, the channel will only need to add 520 new movies to its library every year.

Promotions

On air promotions, interstitial features and special features offer opportunities to position Scene TV. On-air and program promotions will contribute greatly to the quality appearance and entertainment value of the channel. Special theme blocks and hallmark programs such as “Seen on Scene TV” will attract an audience when properly promoted on the service. In addition, interstitial features and host segments will allow us to maintain a high quality perception among the viewers.

Many networks underestimate the value of promotions. However, a large portion of the marketing and positioning of a channel can be accomplished via on-air promotions and special features. When properly combined with programming, break structure, and a graphics package based on the overall channel strategy, Scene TV's promotional strategy will become essential to establishing its position and perception among viewers.

Advertising

Although Scene TV is an advertising supported channel, advertising will be held to a minimum. The national average for advertising on broadcast television is 14 minutes per hour, and 12 minutes on cable networks. Scene TV will restrict its advertising to 8 minutes per hour. Also, advertising messages will be limited to cinema oriented products and services. This will allow Scene TV to preserve a premier appearance while remaining uncluttered for primary advertisers.

Research

It will be vital that appropriate market research is conducted to determine optimal programming methods for Scene TV. The program schedule must be constructed to coincide with the manner in which viewers watch television in general and Scene TV in particular. This research will become especially important as the audience continues to evolve in its viewing habits and is increasingly influenced by the growing availability of new technology and new channels.

A More Complete Discussion of the NETWORK OPERATION FLOWS

1. Programming acquisitions negotiates license agreements with the programming provider and enters the rights information, such as license windows and broadcast rights, into the programming and operation system.

2. Tape traffic orders digital betacam masters of each film from the studio suppliers once the rights information is entered into the operating system.

3. When the tape is received, it's labeled and entered into a database tracking system.

4. Each digital master goes through a quality control process and is then digitized onto a computer file server. The original digital betacam is then stored in a secured tape vault.

5. Programming and Production review each movie licensed and select scenes to be lifted out of each film.

6. Producers and editors prepare the scenes for broadcast by creating broadcast ready files of edited scenes to be sent to playback.

7. Programming reviews the inventory of scenes and creates programming blocks for the movie scenes which may be based on various genres, themes, theatrical release dates, PPV windows, premium pay television windows, network television windows, home video releases, or even blocks featuring scenes from movies in production.

8. Programming takes the broadcast ready scenes and creates 24 hour programming schedules in the operating system.

9. The schedule is sent to Data Services to compile all the necessary data streams to be attached to each individual scene on the schedule giving instructions for the interactive menus.

10. Producers review with programming the promotion strategy for the network as well as each genre block to determine which blocks or themes deserve enhanced promotion such as adding host segments or special graphic elements.

11. After the promotional strategy is completed programming sends the completed schedule to traffic where the broadcast logs for playback are created.

12. Traffic inserts promos, host segments, production credits, network IDs, as directed by programming, and advertising into the broadcast log. They assign the appropriate file numbers to the log and attach the data steams created by Data Services.

13. The broadcast log is locked and sent to the playback automation system where the broadcast signal is originated.

14. The scenes and their respective data streams are encrypted and delivered via satellite to affiliate cable headends and satellite providers.

15. The service is delivered through the cable systems or satellite system to the consumer where the interactive instructions can be decoded by the digital set-top box.

16. The interactive menus can be activated by using the remote control. The interactive menus will guide the consumer to a location to find more information about the movie or purchase related merchandise, broadcast content commerce and electronic content commerce. The locations on the menus will be affiliated with the network with revenue sharing agreements where the affiliate handles the fulfillment of the transactions. Tags will be attached to each order tracking the transaction to the network.

Affiliates will make monthly payments to the network base on the sales transactions delivered by the network.

1. A method and apparatus of providing entertainment content on a television network, the method comprising: excerpting several select scenes from an entertainment production or event, creating themed programming blocks comprised of these scenes, packaging multiple scenes together in a compelling fashion, presenting the packaged scenes in an entertaining and informational context, and delivering the newly created television programming to one or more viewers.

2. The method of claim 1, wherein the entertainment production is a motion picture.

3. The method of claim 2, wherein the motion picture is an originally theatrically released motion picture.

4. The method of claim 2, wherein the motion picture is a made-for-television motion picture.

5. The method of claim 1, wherein the entertainment production is a television program.

6. The method of claim 5, wherein the television program is an episode of television series.

7. The method of claim 6, wherein the television series is a drama.

8. The method of claim 6, wherein the television series is a situation comedy.

9. The method of claim 1, wherein the entertainment event is a sports event.

10. The method of claim 1, wherein the delivering step comprises broadcasting.

11. The method of claim 1, wherein the delivering step comprises wire delivery.

12. The method of claim 1, wherein the delivering step is via the internet.

13. The method of claim 1, wherein the delivering step is via satellite.

14. The method of claim 1, wherein the delivering step is via cable.

15. A television network dedicated to providing scenes of entertainment content comprising: scene programming comprising at least one scene from an entertainment production or event, wherein at least 50% of the network's programming is said scene programming.

16. The method of claim 1, wherein the scene programming is accompanied by interactive television menu selections related to the scene programming which are made available on-screen for the viewer.

17. The method of claim 16, wherein interactive menu selections enable viewers of the network to view and navigate information, product, merchandise, and premium television services lists.

18. The method and apparatus of claim 16, wherein viewers of the network can directly purchase these products, merchandise and services through use of the onscreen interactive television menu selections.

19. The method and apparatus of claim 16, wherein a showing of the motion picture related to the scene programming is sold in its entirety to a viewer via the television network and through use of the onscreen television menu selections.

20. The system and apparatus of claims 18 and 19 in which business partner companies and organizations are directly compensated for the sale of products, merchandise and services which are sold via the network through the onscreen interactive menus.
